(19) United States
(12) Patent Application Publication
(10) Pub. No.: US 2022/0197803 A1
(43) Pub. Date: Jun. 23, 2022

(54) SYSTEM, APPARATUS AND METHOD FOR PROVIDING A PLACEHOLDER STATE IN A CACHE MEMORY

(71) Applicant: Intel Corporation, Santa Clara, CA (US)

(72) Inventors: Ritu Gupta, Sunnyvale, CA (US); Robert Blankenship, Tacoma, WA (US)

(21) Appl. No.: 17/132,216

(22) Filed: Dec. 23, 2020

(51) Int. Cl. G06F 12/0831; G06F 12/0891; G06F 12/0811; G06F 12/0813

(52) U.S. Cl. CPC G06F 12/0835; G06F 12/0813; G06F 12/0811; G06F 12/0891

(57) ABSTRACT

In one embodiment, a system includes an (input/output) I/O domain and a compute domain. The I/O domain includes an I/O agent and a I/O domain caching agent. The compute domain includes a compute domain caching agent and a compute domain cache hierarchy. The I/O agent issues an ownership request to the compute domain caching agent to obtain ownership of a cache line in the compute domain cache hierarchy. In response to the ownership request, the compute domain caching agent places the cache line in the compute domain cache hierarchy in a placeholder state. The placeholder state reserves the cache line for performance of a write operation by the I/O agent. The compute domain caching agent writes data received from the I/O agent to the cache line in the compute domain cache hierarchy and transitions the state of the cache line out of the placeholder state.

### TECHNICAL FIELD

Embodiments relate to data communications in a computing system.

### BACKGROUND

In many cases, increases in the core count in server system on chips (SoC) have led to the use of dis-aggregated dies in SoCs. The dis-aggregated dies are glued together using a high-speed package interface, such as for example, an embedded multi-die interconnect bridge (EMIB). One or more input/output (I/O) agents are often disposed on one die while one or more processor cores are disposed on a separate die. Each individual die has its own cache hierarchy. A memory or a large memory side cache is typically shared across the cache hierarchies associated with each of the dies. Data communications between a processor core on the one die and an I/O agent on the separate die are typically conducted via the memory or the large monolithic memory side cache shared across the cache hierarchies associated with the two different dies. Movement of data from the I/O agent to the processor core often involves multiple data movements across the interconnect fabric and EMIB boundaries. The multiple data movements may result in relatively high data access latencies as well as relatively high interconnect power consumption. In addition, relatively high consumption of both memory bandwidth and die-to-die interconnect (EMIB) bandwidths may occur.

### BRIEF DESCRIPTION OF THE DRAWINGS

FIG. 1 is a block diagram representation of an embodiment of a system.

FIG. 2 is a flowchart representation of an embodiment of a method of implementing a write operation using a placeholder state in a cache.

FIG. 3 is a flowchart representation of an embodiment of a method of implementing a write operation using a placeholder state in a cache.

FIG. 4 is a flowchart representation of an embodiment of a method of implementing a write operation using a placeholder state in a cache.

FIG. 5 is a transaction diagram illustrating examples of transactions involved in an embodiment of a write operation using a placeholder state in a cache.

FIG. 6 is a transaction diagram illustrating examples of transactions involved in an embodiment of a write operation using a placeholder state in a cache.

FIGS. 7A and 7B illustrate block diagrams of core architectures.

FIG. 8 is a block diagram of a processor that may have more than one core, may have an integrated memory controller, and may have integrated graphics according to various embodiments.

FIG. 9 is a block diagram of a first more specific exemplary system in accordance with an embodiment.

FIG. 10 is a block diagram of a SoC in accordance with an embodiment.

FIG. 11 is a block diagram contrasting the use of a software instruction converter to convert binary instructions in a source instruction set to binary instructions in a target instruction set according to various embodiments.

### DETAILED DESCRIPTION

Standard cache coherency protocols, such as for example the MESI protocol, include a modified M cache state, an exclusive E cache state, a shared S cache state, and an invalid I cache state. A placeholder P cache state may be added to the existing MESI protocol to create a MESIP protocol. The placeholder P cache state enables an agent associated with one cache hierarchy and to obtain ownership of a cache line in a different cache hierarchy.

This concept can be applied to the performance of a write operation by an (input/output) I/O agent at a I/O domain to a cache line in a compute domain cache hierarchy in a compute domain. An I/O domain typically includes one or more I/O devices, one or more I/O agents, a I/O domain cache hierarchy, and a I/O domain caching agent. A compute domain typically includes one or more cores, a compute domain cache hierarchy, and a compute domain caching agent. The new placeholder P cache state enables the I/O agent in the I/O domain to write I/O data to a cache line in a L3 cache of the compute domain cache hierarchy, in an embodiment.

More specifically, the I/O agent requests ownership of a cache line in the compute domain cache hierarchy from the compute domain caching agent. In response to the ownership request, the compute domain caching agent places the cache line in the compute domain cache hierarchy in the placeholder P cache state. When the cache line is placed in the placeholder P cache state, the cache line is reserved for the I/O agent to perform a write operation to that cache line. The placeholder P cache state provides temporary ownership of the cache line in the compute domain cache hierarchy to the I/O agent without providing the contents of the cache line to the I/O agent. When the cache line is placed in the placeholder P cache state the content of the cache line is dirty with respect to memory. Upon receiving ownership of the cache line, the I/O agent transmits I/O data to the compute domain caching agent via the I/O domain caching agent to write to the cache line. Upon completion of the write operation, the cache line is transitioned out of the placeholder P cache state to the modified M cache state, in an embodiment.

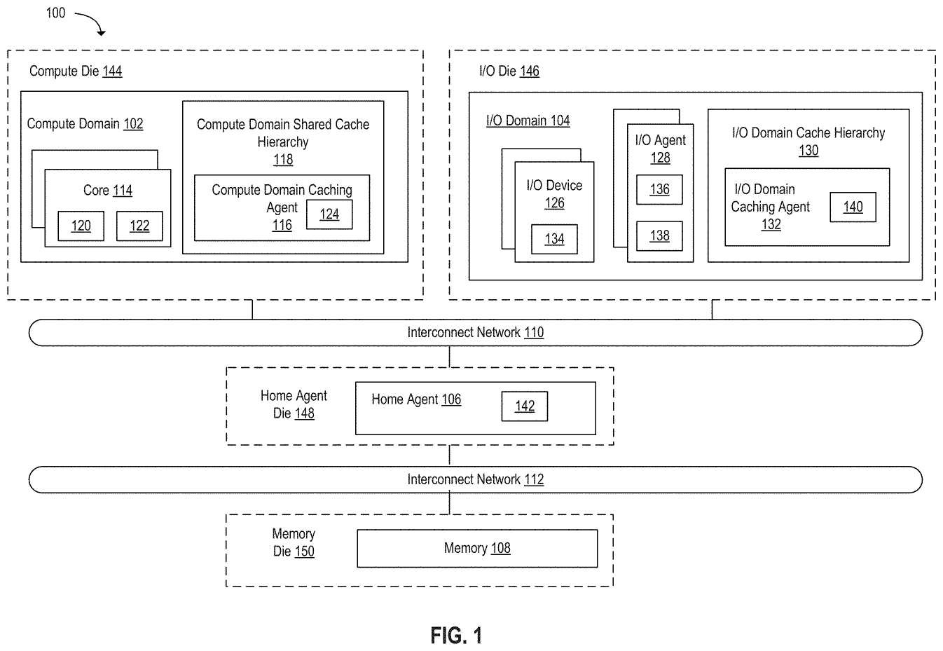

Referring to FIG. 1, a block diagram representation of an embodiment of a system 100 is shown. The system 100 may be at least a portion of, for example, a server computer, a desktop computer, or a laptop computer. The system 100 includes a compute domain 102, an input/output (I/O) domain 104, a home agent 106, and a memory 108. The compute domain 102, the I/O domain 104, and the home agent 106 are coupled via an interconnect network 110. The home agent 106 is coupled to the memory 108 via an interconnect network 112. In an embodiment, communications within the compute domain 102 and the I/O domain 104 are supported by an Intra-Die Interconnect (IDI) protocol and communications across the compute domain 102, the I/O domain 104, and the home agent 106 are supported by an Intel® Ultra Path Interconnect (UPI) protocol. In other embodiments, alternative interconnect protocols may be used. In an embodiment, data communications across the compute domain 102 and the I/O domain 104 are conducted via the home agent 106.

While the system 100 is shown as having a single compute domain 102, a single input/output domain 104, a single home agent 106, and a single memory 108, alternative embodiments of the system 100 may include multiple compute domains 102, multiple input/output domains 104, multiple home agents 106, and/or multiple memories 108. The system 100 may include additional components that facilitate the operation of the system 100. Furthermore, while an example of interconnect networks 110, 112 illustrating the coupling between the different components of the system 100 are shown, alternative network configurations may be used to couple the components of the system 100.

The compute domain 102 includes one or more cores 114, a compute domain cache hierarchy, and a compute domain caching agent 116. The compute domain cache hierarchy includes a compute domain shared cache hierarchy 118. An example of a compute domain shared cache hierarchy 118 is a L3 cache. The compute domain shared cache hierarchy 118 is shared by and accessible to the one or more cores 114 in the compute domain 102. Each core 114 includes a hardware circuit, such as a control circuit 120, to execute core operations and a core cache hierarchy 122. The compute domain cache hierarchy includes the core cache hierarchy 122. The core cache hierarchy 122 includes a L1 cache and a L2 cache. The compute domain caching agent 116 manages operations associated with the compute domain cache hierarchy. To this end, the compute domain caching agent 116 includes a hardware circuit, such as a control circuit 124, to manage the operations. The compute domain 102 may include additional components that facilitate operation of the compute domain 102.

The I/O domain 104 includes one or more I/O devices 126, one or more I/O agents 128, a I/O domain cache hierarchy 130, and a I/O domain caching agent 132. Each of the I/O agents 128 is coupled to one or more I/O devices 126. The I/O domain cache hierarchy 130 is coupled to and shared by the one or more I/O agents 128. An example of an I/O domain cache hierarchy 130 is a L3 cache. Each I/O device 126 includes a hardware circuit, such as a control circuit 134, to manage I/O device operations. Each I/O agent 128 includes a hardware circuit, such as a control circuit 136, to manage I/O agent operations and an internal cache 138. The internal cache 138 may also be referred to as a write buffer. Examples of I/O agents 128 include, but are not limited to, accelerator instances such as a data streaming accelerator (DS)A/HMQ/IAX, and a host processor with multiple I/O devices 126 connected downstream. The I/O domain caching agent 132 includes a hardware circuit, such as a control circuit 140, to manage the cache operations. The I/O domain 104 may include additional components that facilitate the operation of the I/O domain 104.

In an embodiment, the compute domain 102 is disposed on a compute die 144 and the I/O domain 104 is disposed on an I/O die 146. In an embodiment, the home agent 106 is disposed on a home agent die 148 and the memory 108 is disposed on a memory die 150. In alternative embodiments, the home agent 106 may be disposed on one of the compute die, the I/O die, or the memory die. In alternative embodiments, multiple compute domains 102 may be disposed on a single compute die 144 and/or multiple I/O domains 104 may be disposed on single I/O die 146. In an embodiment, the compute domain 102 and the home agent 106 are components of a local socket. In an alternative embodiment, the compute domain 102 and the home agent 106 are components of a remote socket.

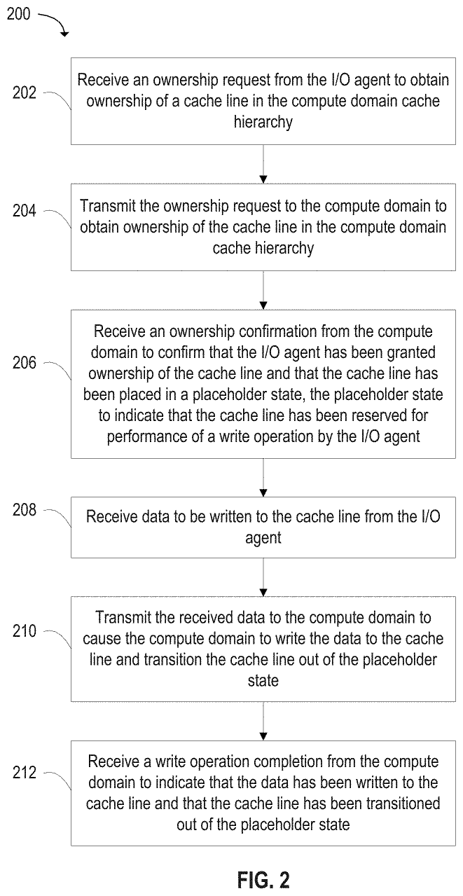

Referring to FIG. 2, a flowchart representation of an embodiment of a method 200 of implementing a write operation using a placeholder P state in the compute domain cache hierarchy is shown. The method 200 is performed when an I/O agent 128 writes data to a cache line in the compute domain 102. The method 200 may be performed by the I/O domain 104 in combination with additional components of the system 100. The method 200 may be performed by hardware circuitry, firmware, software, and/or combinations thereof.

At 202, the I/O domain caching agent 132 receives an ownership request from an I/O agent 128 to obtain ownership of a cache line in the compute domain cache hierarchy. In an embodiment, the compute domain cache hierarchy includes the compute domain shared cache hierarchy 118 and the core cache hierarchy 122. In an embodiment, the I/O domain caching agent 132 receives an ownership request for a cache line in the L3 cache in the compute domain shared cache hierarchy 118. In alternative embodiments, the I/O domain caching agent 132 may receive an ownership request for a cache line in the L1 cache or the L2 cache in the core cache hierarchy 122.

At 204, responsive to the ownership request from the I/O agent 128, the I/O domain caching agent 132 transmits the ownership request to the compute domain 102 to obtain ownership of the cache line in the compute domain cache hierarchy. In an embodiment, the ownership request is transmitted from the I/O domain caching agent 132 to the home agent 106 and the home agent 106 transmits the received ownership request to the compute domain caching agent 116.

The home agent 106 includes a home snoop filter. The home snoop filter is a tracking structure that indicates which core 114 on a socket or a glueless socket system has the line cached. This helps the home agent 106 to send a directed message to the correct compute domain caching agent 132. Home snoop filter is present in this specific implementation and may not exist in others.

At 206, the I/O domain caching agent 132 receives an ownership confirmation from the compute domain 102 confirming that the I/O agent 128 has been granted ownership of the cache line in the compute domain cache hierarchy and that the cache line has been placed in the placeholder P state. In an embodiment, the I/O domain caching agent 132 receives the ownership confirmation from the compute domain caching agent 116. The placeholder P state indicates that the cache line has been reserved for the performance of a write operation by the I/O agent 128. The placeholder P state grants temporary ownership of the cache line to the I/O agent 128. The I/O agent 128 receives ownership of the cache line without receipt of the content of the cache line. The placeholder P state indicates that the cache line is dirty with respect to memory. The state of the cache line is transitioned from one of the invalid I state or the modified M state to the placeholder P state.

At 208, the I/O domain caching agent 132 receives the data to be written to the cache line from the I/O agent 128. In an embodiment, the received data is I/O data. In an embodiment, the I/O domain caching agent 132 receive the data to be written to the cache line from the internal cache 138 of the I/O agent 128.

At 210, the I/O domain caching agent 132 transmits the data received from the I/O agent 128 to the compute domain 102 to cause the compute domain 102 to write the data to the cache line in the compute domain cache hierarchy that has been placed in the placeholder P state and transition the cache line out of the placeholder P state. In an embodiment, the I/O domain caching agent 132 transmits the data to be written to the cache line in the compute domain cache hierarchy to the compute domain caching agent 116 and the compute domain caching agent 116 writes the received data to the cache line. In an embodiment, the I/O domain caching agent 132 transmits the date to the home agent 106 and the home agent 106 transmits the received data to the compute domain caching agent 116.

At 212, the I/O domain caching agent 132 receives a write operation completion from the compute domain 102 indicating that the data has been written to the cache line in the compute domain cache hierarchy and that the cache line has been transitioned out of the placeholder P state. Once the cache line in the compute domain cache hierarchy is transitioned out of the placeholder P state, the I/O agent 128 no longer has ownership of the cache line. In an embodiment, the cache line is transitioned from the placeholder P state to one of the invalid I state or the modified M state. It is to be understood that the method 200 is shown at a high level in FIG. 2 and that many variations in and alternatives of the method 200 are possible.

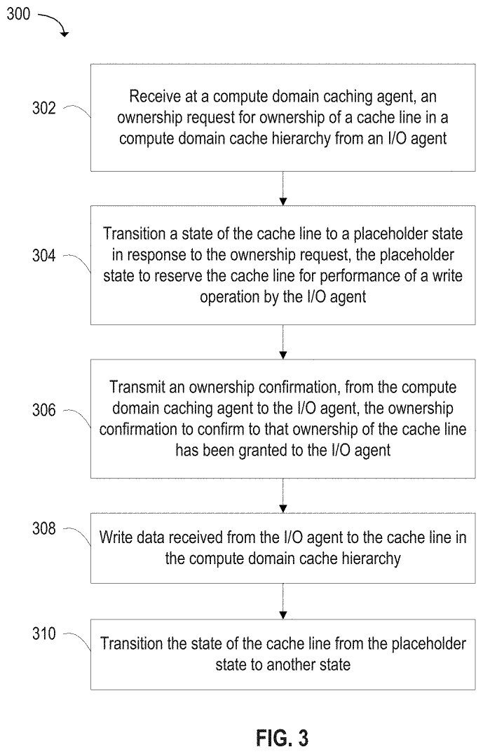

Referring to FIG. 3, a flowchart representation of an embodiment of a method 300 of implementing a write operation using a placeholder P state in the compute domain 102 is shown. The method 300 is performed when the compute domain 102 performs a write operation at the compute domain cache hierarchy using data received from an I/O agent 128 in the I/O domain 104. The method 300 may be performed by the compute domain 102 in combination with additional components of the system 100. The method 300 may be performed by hardware circuitry, firmware, software, and/or combinations thereof.

At 302, the compute domain caching agent 116 in the compute domain 102 receives an ownership request for ownership of a cache line in the compute domain cache hierarchy from an I/O agent 128 in the I/O domain 104. In an embodiment, the compute domain caching agent 116 receives an ownership request for a cache line in the L3 cache in the compute domain shared cache hierarchy 118. In alternative embodiments, the compute domain caching agent 116 may receive an ownership request for a cache line in the L1 cache or the L2 cache in the core cache hierarchy 122. In an embodiment, the ownership request is received from the I/O agent 128 at the compute domain caching agent 116 via the I/O domain caching agent 132. In an embodiment, the ownership request is received at the compute domain caching agent 116 from the I/O agent via the I/O domain caching agent 132 and the home agent 106.

At 304, in response to the ownership request, the compute domain caching agent 116 transitions the state of the cache line in the compute domain cache hierarchy to a placeholder P state. The placeholder P state reserves the cache line in the compute domain cache hierarchy for the performance of a write operation by the I/O agent 128 by granting temporary ownership of the cache line to the I/O agent 128. The placeholder P state indicates that the cache line is dirty with respect to memory. The state of the cache line is transitioned from one of the invalid I state or the modified M state to the placeholder P state.

At 306, the compute domain caching agent 116 transmits an ownership confirmation to the I/O agent 128 confirming that ownership of the cache line has been granted to the I/O agent 128. In an embodiment, the compute domain caching agent 116 transmits the ownership confirmation to the I/O agent 128 via the I/O domain caching agent 132. In an embodiment, the compute domain caching agent 116 transmits the ownership confirmation to the home agent 106 and the home agent 106 transmits the ownership confirmation to the I/O domain caching agent 132 for transmission to the I/O agent 128. The ownership of the cache line is granted to the I/O agent 128 without the transmission of the content of the cache line to the I/O agent 128.

At 308, the compute domain caching agent 116 writes data received from the I/O agent 128 to the cache line in the compute domain cache hierarchy that has been placed in the placeholder P state. In an embodiment, the data from the I/O agent 128 is received at the compute domain caching agent 116 via the I/O domain caching agent 132. In an embodiment the data is received at from the I/O domain caching agent 132 at the compute domain caching agent 116 via the home agent 106. In an embodiment, the data received from the I/O agent 128 at the compute domain caching agent 116 is I/O data. In an embodiment, the compute domain caching agent 116 writes the received data to the cache line in the L3 cache in the compute domain shared cache hierarchy 118. In alternative embodiments, the compute domain caching agent 118 writes the received data to the cache line in one of the L1 cache or the L2 cache in the core cache hierarchy 122.

At 310, the compute domain caching agent 116 transitions the state of the cache line in the compute domain cache hierarchy from the placeholder P state to another state. In an embodiment, the compute domain caching agent 116 transitions the state of the cache line in the compute domain cache hierarchy from the placeholder P state to one of the invalid I state or the modified M state. It is to be understood that the method 300 is shown at a high level in FIG. 3 and that many variations in and alternatives of the method 300 are possible.

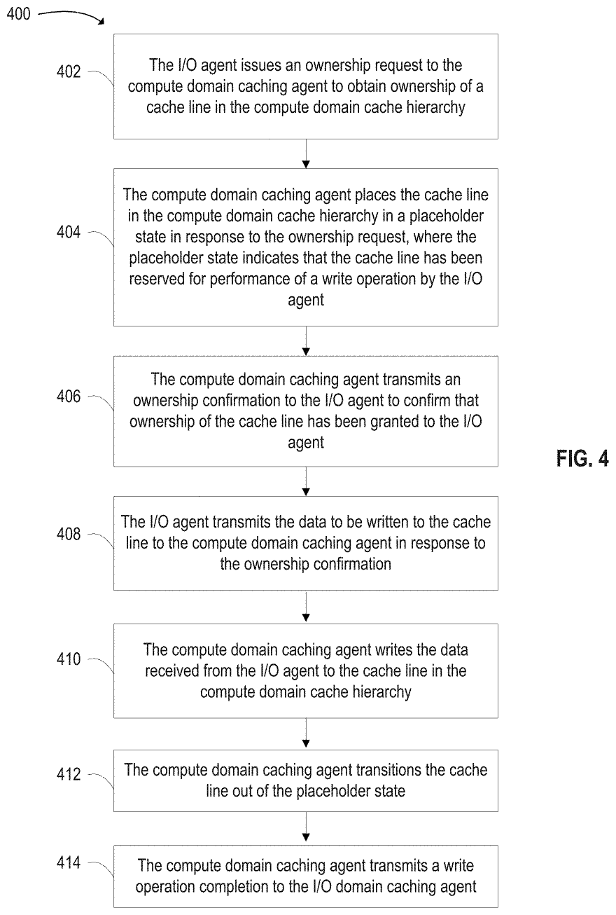

Referring to FIG. 4, a flowchart representation of an embodiment of a method 400 of implementing a write operation using a placeholder P state in the compute domain cache hierarchy is shown. The method 400 is performed when a I/O agent 128 in the I/O domain 104 writes data to the compute domain cache hierarchy in the compute domain 102. The method 400 may be performed by components of the I/O domain 104 and components of the compute domain 102 in combination with additional components of the system 100. The method 400 may be performed by hardware circuitry, firmware, software, and/or combinations thereof.

At 402, the I/O agent 128 in the I/O domain 104 issues an ownership request to the compute domain caching agent 116 to obtain ownership of a cache line in the compute domain cache hierarchy in the compute domain 102. In an embodiment, the I/O agent 128 transmits the ownership requests to the I/O domain caching agent 132 and the I/O domain caching agent 132 transmits the ownership request to the compute domain caching agent 116. In an embodiment, the I/O domain caching agent 132 transmits the ownership request to the compute domain caching agent 116 via the home agent 106. In an embodiment, the compute domain cache hierarchy includes the compute domain shared cache hierarchy 118 and the core cache hierarchy 122. In an embodiment, the I/O agent 128 transmits an ownership request for a cache line in the L3 cache in the compute domain shared cache hierarchy 118. In alternative embodiments, the I/O agent 128 may transmit an ownership request for a cache line in the L1 cache or the L2 cache in the core cache hierarchy 122.

At 404, the compute domain caching agent 116 places the cache line in the compute domain cache hierarchy in a placeholder P state in response to the ownership request. The placeholder P state indicates that the cache line has been reserved for performance of a write operation by the I/O agent 128 by granting temporary ownership of the cache line to the I/O agent 128. The placeholder P state indicates that the cache line is dirty with respect to memory. The state of the cache line is transitioned from one of the invalid I state or the modified M state to the placeholder P state.

At 406, the compute domain caching agent 116 transmits an ownership confirmation to the I/O agent 128 to confirm that ownership of the cache line has been granted to the I/O agent 128. In an embodiment, the compute domain caching agent 116 transmits the ownership confirmation to the I/O agent 128 via the I/O domain caching agent 132. In an embodiment, the compute domain caching agent 116 transmits the ownership confirmation to the home agent 106 and the home agent 106 transmits the ownership confirmation to the I/O domain caching agent 132 for transmission to the I/O agent 128. The ownership is granted to the I/O agent 128 without the transmission of the content of the cache line to the I/O agent 128.

At 408, the I/O agent 128 transmits the data to be written to the cache line in the compute domain cache hierarchy to the compute domain caching agent 116 in response to the ownership confirmation. The I/O agent 128 transmits the data to the I/O domain caching agent 132. The I/O domain caching agent 132 transmits the received data to the compute domain caching agent 116. In an embodiment, The I/O domain caching agent 132 transmits the received data to the compute domain caching hierarchy 116 via the home agent 106. In an embodiment, the data is I/O data.

At 410, the compute domain caching agent 116 writes the data received from the I/O agent 128 to the cache line in the compute domain cache hierarchy that has been placed in the placeholder P state. In an embodiment, the compute domain caching agent 116 writes the received data to the cache line in the L3 cache in the compute domain shared cache 118. In alternative embodiments, the compute domain caching agent 116 writes the received data to the cache line in one of the L1 cache or the L2 cache in the core cache hierarchy 122.

At 412, the compute domain caching agent 116 transitions the cache line out of the placeholder P state. In an embodiment, the compute domain caching agent 116 transitions the state of the cache line in the compute domain cache hierarchy from the placeholder P state to one of the invalid I state or the modified M state.

At 414, the compute domain caching agent 116 transmits a write operation completion to the I/O domain caching agent 132. In an embodiment, the compute domain caching agent 116 transmits the write operation completion to the home agent 106 and the home agent 106 transmits the write operation completion to the I/O domain caching agent 132. The write operation completion indicates to the I/O domain caching agent 132 that the data has been written to the cache line in the compute domain cache hierarchy and that I/O agent 128 no longer has ownership of the cache line. It is to be understood that the method 400 is shown at a high level in FIG. 4 and that many variations in and alternatives of the method 400 are possible.

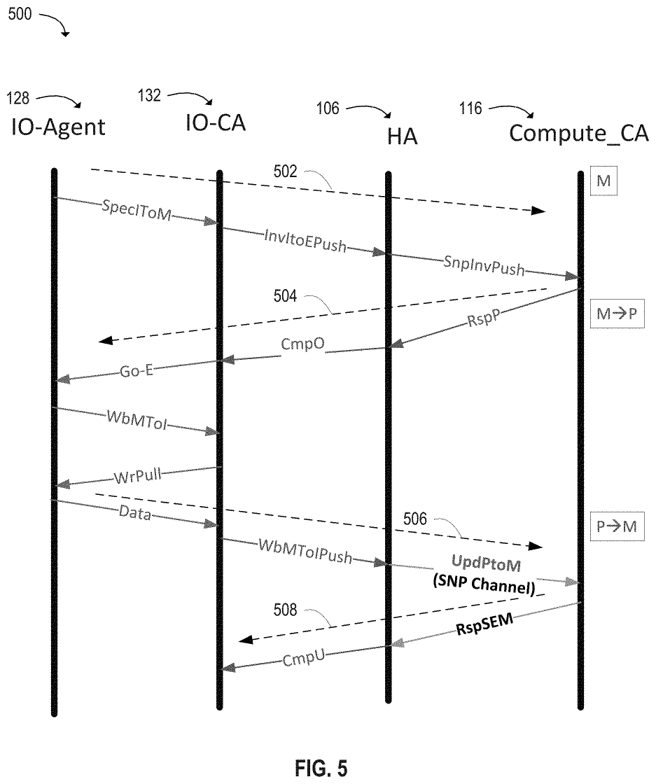

Referring to FIG. 5, a transaction diagram 500 illustrating examples of transactions involved in an embodiment of a write operation using a placeholder P state is shown. The transactional diagram 500 illustrates transactions performed by the I/O agent 128, the I/O domain caching agent 132, the home agent 106, and the compute domain caching agent 116. The transactions may be performed by hardware circuitry, firmware, software, and/or combinations thereof.

The I/O agent 128 issues an ownership request 502 to the compute domain caching agent 116 via the I/O domain caching agent 132 and the home agent 106 to obtain ownership of a cache line that the I/O agent 128 would like to write to in the compute domain cache hierarchy. In an embodiment, the I/O agent 128 requests ownership of a cache line in the L3 cache in the compute domain shared cache hierarchy 118. In alternative embodiments, the I/O agent 128 may request ownership of a cache line in the L2 cache or in the L1 cache in the core cache hierarchy 122.

The ownership request 502 includes three transactions, transmission of a protocol message SpeclToM, transmission of a protocol message InvltoEPush and transmission of a snoop message SnpInvPush. The I/O agent 128 transmits the protocol message SpeclToM to the I/O domain caching agent 132. The protocol message SpeclToM is a protocol Opcode where the I/O agent 128 issues a request to own a cache line in the compute domain cache hierarchy to the I/O domain caching agent 132. In embodiments where the request is from a PCIe I/O device, the request is speculative since the PCIe I/O device may or may not write to the cache line. In alternative embodiments, accelerators issue a non-speculative request since once an accelerator requests ownership of a cache line, the accelerator will be writing data to that cache line.

Responsive to the protocol message SpeclToM, the I/O domain caching agent 132 transmits the protocol message InvltoEPush to the home agent 106. Responsive to the protocol message InvltoEPush, the home agent 106 transmits the snoop message SnpInvPush to the compute domain caching agent 116 via a snoop channel. The snoop message SnpInvPush seeks to invalidate the cache line at the compute domain cache hierarchy and transition the cache line to the placeholder P state.

Responsive to the snoop message SnpInvPush, the compute domain caching agent 116 transitions the state of the cache line in the compute domain cache hierarchy from the modified M state to the placeholder P state. The placeholder P state indicates that the cache line has been reserved for performance of a write operation by the I/O agent 128. Placing the cache line in the placeholder P state grants the I/O agent 128 temporary ownership of the cache line in the compute domain cache hierarchy. When the cache line is placed in the placeholder P state, the cache line in the compute domain cache hierarchy is in a dirty state with respect to a memory.

The compute domain caching agent 116 transmits an ownership confirmation 504 to the I/O agent 128 via the home agent 106 and the I/O domain caching agent 132 confirming that ownership of the cache line in the compute domain cache hierarchy has been granted to the I/O agent 128. The ownership confirmation 504 includes three transactions. In the first transaction, the compute domain caching agent 116 issues an ownership confirmation RspP to the home agent 106 via the snoop channel confirming that the I/O agent 128 has been granted ownership of the cache line in the compute domain cache hierarchy and that the cache line has been placed in the placeholder P state. The ownership confirmation RspP indicates a successful response to the snoop message SnpInvPush.

Responsive to the receipt of the ownership confirmation RspP, the home agent 106 engages in the second transaction where the home agent 106 issues an ownership confirmation CmpO to the I/O domain caching agent 132. The home agent 106 sends the CmpO message to the I/O domain caching agent 132 to acknowledge that the I/O agent 128 has been granted ownership of the cache line in the compute domain hierarchy. Upon receipt of the CmpO message, the I/O domain caching agent 132 engages in the third transaction by transmitting a Go-E message to the I/O agent 128 indicating that ownership of the cache line in the compute domain cache hierarchy has been granted to the I/O agent 128.

Upon receipt of the Go-E message, the I/O agent 128 transmits the data 506 to be written to the cache line in the placeholder P state in the compute domain hierarchy to the compute domain caching agent 116 via the I/O domain caching agent 132 and the home agent 106. The data transmission 506 includes a plurality of transactions.

The transmission of the data from the I/O agent 128 to the I/O domain caching agent 132 involves a series of transactions. The series of transactions includes the transmission of a writeback message WbMTol from the I/O agent 128 to the I/O domain caching agent 132, transmission of a WrPull request from the I/O domain caching agent 132 to the I/O agent 128, and the transmission of data from the I/O agent 128 to the I/O domain caching agent 132.

Responsive to the receipt of data from the I/O agent 128, the I/O domain caching agent 132 engages in a transaction WbMTolPush where the I/O domain caching agent 132 transmits the data to the home agent 106. The home agent 106 transmits the data received from the I/O domain caching agent 132 to the compute domain caching agent 116 via the snoop channel using a protocol message UpdPtoM. The protocol message UpdPtoM indicates that the transaction uses the UPI protocol, that the transaction will involve the writing of modified data received from the I/O agent 128 to the cache line in the placeholder P state at the compute domain cache hierarchy, and that the cache line will be transitioned from the placeholder P state to the modified M state following the completion of the write operation.

Once the I/O agent 128 has the ownership of the cache line in the compute domain cache hierarchy, the I/O agent 128 may potentially write the cache line in the write buffers. The dirty line inside the I/O Agent is written back to the I/O domain caching agent 132 and then to the home agent 106. A lookup at the snoop filter at the home agent 106 indicates that the cache line in the L3 cache of the compute domain cache hierarchy is held in the placeholder P state. A snoop with data is issued from the home agent 106 to the compute domain caching agent 116 to update the L3 cache in the compute domain cache hierarchy with the new data. As a result, the cache line is pushed into the L3 cache of the compute domain cache hierarchy. In alternative embodiments, the data may be pushed into the L3 cache in the compute domain cache hierarchy in the request channel.

Upon receipt of the protocol message UpdPtoM, the compute domain caching agent 116 writes the data to the cache line in the compute domain cache hierarchy and transitions the state of the cache line from the placeholder P state to the modified M state.

The compute domain caching agent 116 transmits a write operation completion 508 to the I/O domain caching agent 132 via the home agent 106. The write operation completion 508 includes two transactions. The first transaction involves the compute domain caching agent 116 transmitting a completion response RspSEM to the home agent 106 via the snoop channel. The second transaction involves the home agent 106 responsively transmitting a final handshake completion CmpU to the I/O domain caching agent 132. It is to be understood that the transactions illustrated in FIG. 5 are shown at a high level and that many variations in and alternatives of the transactions are possible.

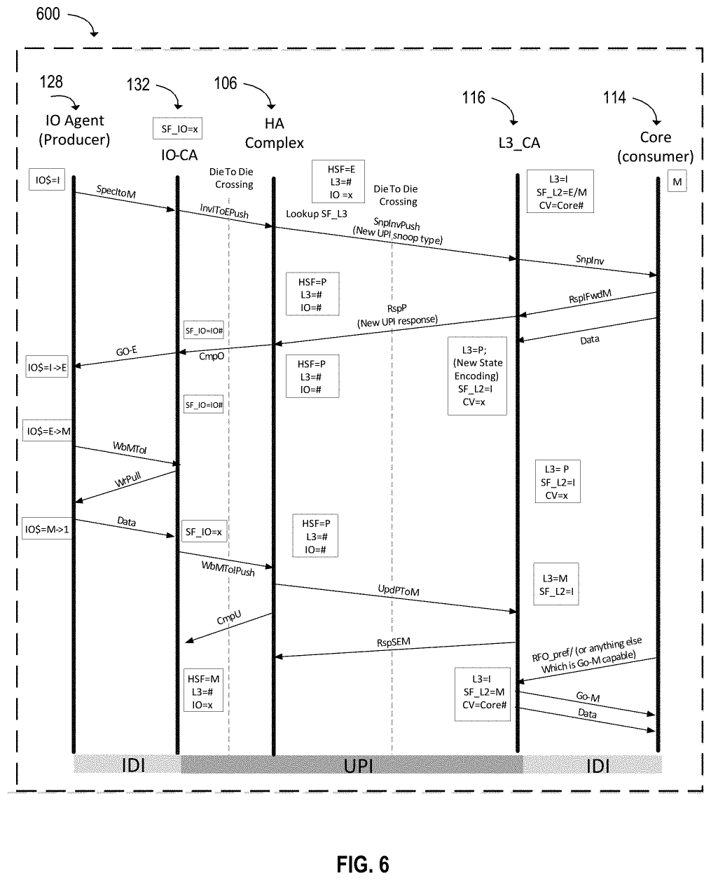

FIG. 6 is a transaction diagram 600 illustrating examples of transactions involved in an embodiment of an implementation of a write operation using a placeholder P state a cache. The transactional diagram 600 illustrates transactions performed by the I/O agent 128, the I/O domain caching agent 132, the home agent 106, the compute domain caching agent 116, and the core 114. The transactions may be performed by hardware circuitry, firmware, software, and/or combinations thereof.

The transactions between the I/O agent 128, I/O domain caching agent 132, the home agent 106, and the compute domain caching agent 116 have been detailed in FIG. 5. FIG. 6 illustrates additional transactions between the compute domain caching agent 116 and the core 114. These additional transactions will be described in further detail below.

Upon receipt of the ownership request 502, the compute domain caching agent 116 transmits a message SNPInv to the core 114 to request that the core 114 invalidate any cached copy of a physical address in the cache line and return the dirty data in the cache line back to the compute domain caching agent 116. The core 114 invalidates the cache line and transmits the dirty data to the compute domain caching agent 116. The compute domain caching agent 116 issues snoops to invalidate the cache line if cached inside the core 114 and return the cache line back to the compute domain caching agent 116 and installing it at the L3 cache in the compute domain cache hierarchy.

The core 114 transmits a RSPFwdM message to the compute domain caching agent 116 confirming that the cache line has been invalidated and that the dirty data Data has been transmitted to the compute domain caching agent 116. Responsive to the RSPFwdM message, the compute domain caching agent 116 transmits the ownership confirmation 504 to the I/O agent 128 via the home agent 106 and the I/O domain caching agent 132 as described with reference to FIG. 5 above.

Once the compute domain caching agent 116 receives the dirty data Data if any back from the core 114 and installs this in the L3 cache of the compute domain cache hierarchy, the compute domain caching agent 116 transitions the cache line in the L3 cache to the placeholder P state and returns an acknowledgement back to the home agent 106. The snoop filter state at the home agent 106 is updated to placeholder P state as well to indicate that I/O agent 128 owns a cache line in a L3 cache in the compute domain hierarchy.

Once the compute Domain caching agent 116 receives the dirty Data from the Home agent 106 on the snoop channel, the placeholder state P transitions to M. At some future point, the core 114 can issue a demand request to read the Data written by the I/O Agent by issuing a Demand read. The compute domain caching agent 116 transmits the data Data to the core 114 and the response Go-M which indicates that the core 114 has ownership of the line. It is to be understood that the transactions illustrated in FIG. 6 are shown at a high level and that many variations in and alternatives of the transactions are possible.

In various embodiments, use of the placeholder P state may result in relatively lower data access latencies, relatively lower interconnect power consumption, as well as relatively lower consumption of memory bandwidth and die-to-die interconnect (EMIB) bandwidth. A reduction in the number of die-to-die/UPI crossings may result in relatively lower die-to-die (EMIB) crossing bandwidth for data. Furthermore, data from the I/O domain is pushed to a cache level that is relatively close to the core. For example, the data may be pushed to the core L3 level cache or in some cases to the core L2 cache level or the core L1 cache level. In cases where the I/O data is already cached at a specific level in the I/O domain caching hierarchy, coherency protocols honor snoop filter states. In addition, data flows between the compute domain and local I/O domains are similar to data flows between the compute domain and remote I/O domains.

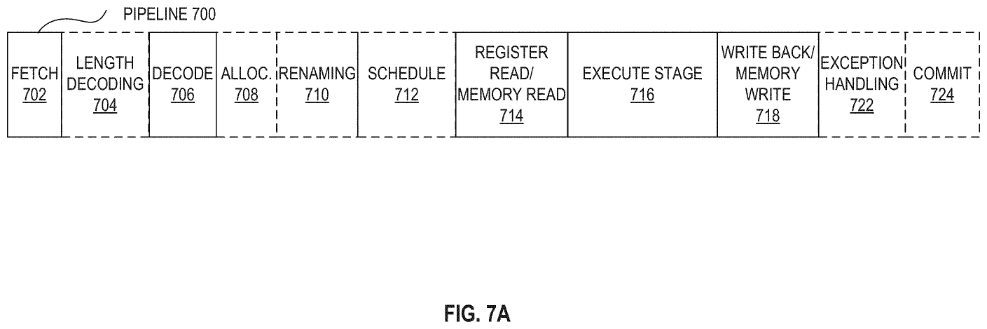

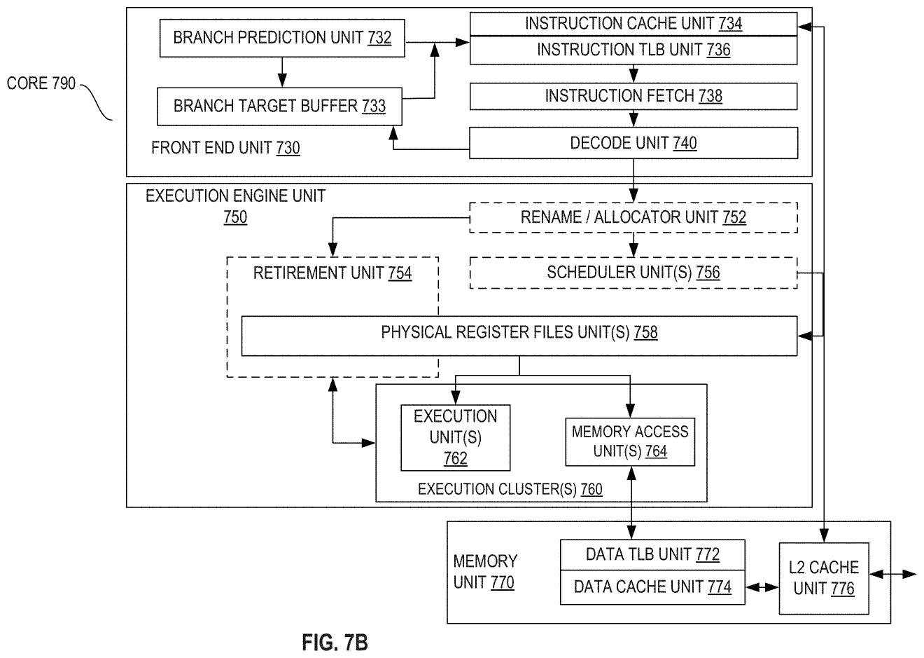

Understand that embodiments may be used in connection with many different processor architectures. FIG. 7A is a block diagram illustrating both an exemplary in-order pipeline and an exemplary register renaming, out-of-order issue/execution pipeline according to various embodiments. FIG. 7B is a block diagram illustrating both an exemplary embodiment of an in-order architecture core and an exemplary register renaming, out-of-order issue/execution architecture core to be included in a processor according to various embodiments. In various embodiments, the described architecture may be used to implement a write operation performed by an I/O agent in an I/O domain at a compute cache hierarchy in the compute domain. The solid lined boxes in FIGS. 7A and 7B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724. Note that as described herein, in a given embodiment a core may include multiple processing pipelines such as pipeline 700.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

As further shown in the front end unit 730, the branch prediction unit 732 provides prediction information to a branch target buffer 733.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor. Note that an embodiment of the execution engine unit 750 described above may place a cache line in the shared L2 cache unit 776 or the L1 internal cache in a placeholder state in response to a request for ownership of the cache line from an I/O agent in an I/O domain thereby reserving the cache line for the performance of a write operation by the I/O agent using embodiments herein.

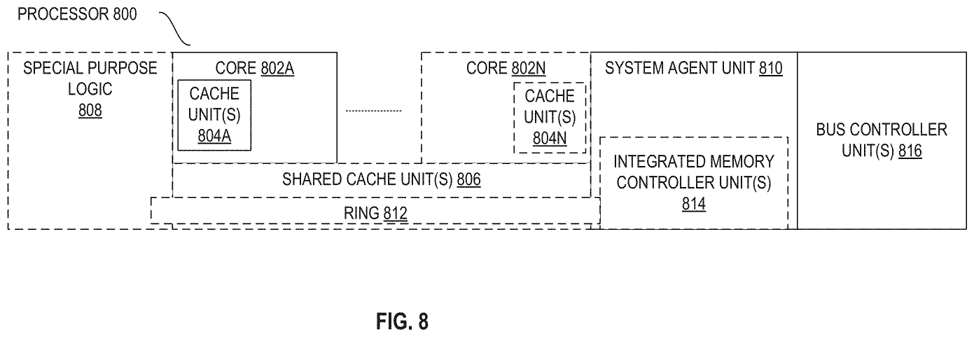

FIG. 8 is a block diagram of a processor 800 that may have more than one core, may have an integrated memory controller, and may have integrated graphics according to various embodiments. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-N, a set of one or more integrated memory controller unit(s) in the system agent unit 810, and a special purpose logic 808, which may perform one or more specific functions.

Thus, different implementations of the processor 800 may include: 1) a CPU with a special purpose logic being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache units 804A-N within the cores, a set or one or more shared cache units 806, and external memory (not shown) coupled to the set of integrated memory controller units 814. The set of shared cache units 806 may include one or more mid-level caches, such as level 2 (L2), level 3 (L3), level 4 (L4), or other levels of cache, a last level cache (LLC), and/or combinations thereof. While in one embodiment a ring based interconnect unit 812 interconnects the special purpose 808, the set of shared cache units 806, and the system agent unit 810/integrated memory controller unit(s) 814, alternative embodiments may use any number of well-known techniques for interconnecting such units.

The system agent unit 810 includes those components coordinating and operating cores 802A-N. The system agent unit 810 may include for example a power control unit (PCU) and a display unit. The PCU may be or include logic and components needed for regulating the power state of the cores 802A-N and the special purpose logic 808. The display unit is for driving one or more externally connected displays.

The cores 802A-N may be homogenous or heterogeneous in terms of architecture instruction set; that is, two or more of the cores 802A-N may be capable of execution the same instruction set, while others may be capable of executing only a subset of that instruction set or a different instruction set. In an embodiment, a cache line in one of the shared cache units 806 or one of the core cache units 804A-804N may be placed in a placeholder state in response to a cache line ownership request received from an I/O agent in an I/O domain thereby reserving the cache line for the performance of a write operation by the I/O agent as described herein.

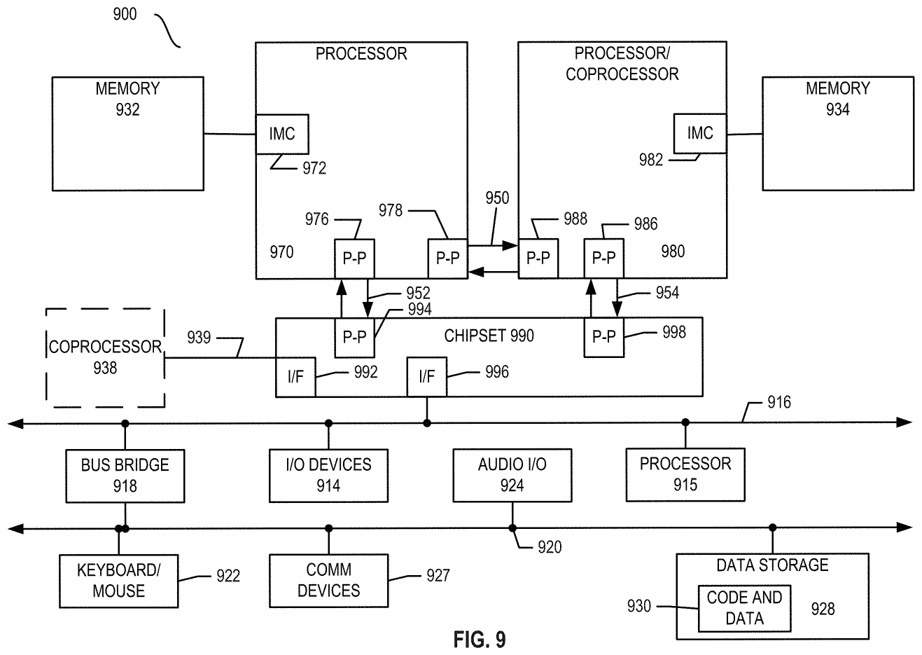

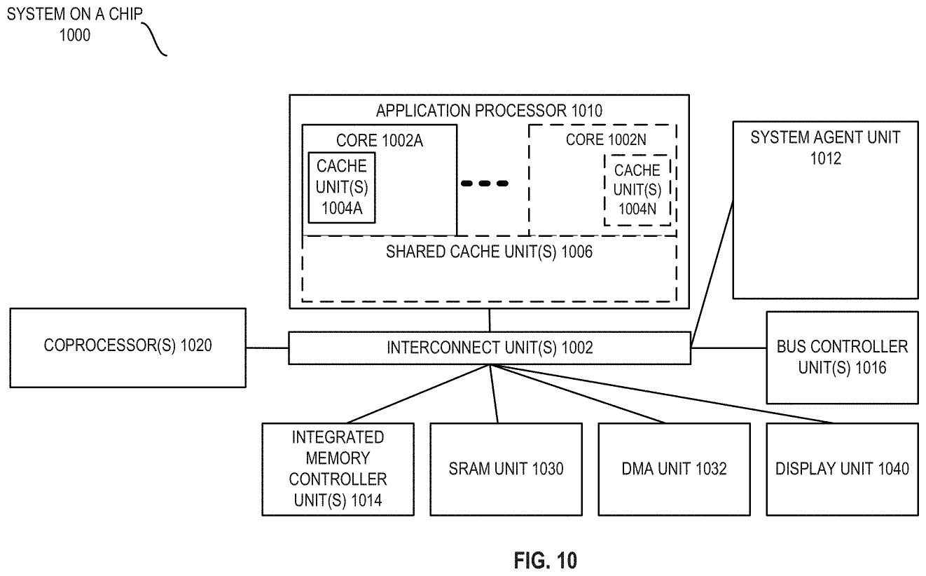

FIGS. 9-10 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a first more specific exemplary system 900 in accordance with an embodiment. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 800.

Processors 970 and 980 are shown including integrated memory controller (IMC) units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, integrated memory controllers (IMCs) 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 939. In one embodiment, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode. In embodiments, a cache line in the shared cache or the local cache may be placed in a placeholder state in response to an ownership request from an I/O agent in an I/O domain thereby reserving the cache line for the performance of a write operation by the I/O agent.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope is not so limited.

As shown in FIG. 9, various I/O devices 914 may be coupled to first bus 916, along with a bus bridge 918 which couples first bus 916 to a second bus 920. In one embodiment, one or more additional processor(s) 915, such as coprocessors, high-throughput MIC processors, GPGPU's, accelerators (such as, e.g., graphics accelerators or digital signal processing (DSP) units), field programmable gate arrays, or any other processor, are coupled to first bus 916. In one embodiment, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

Referring now to FIG. 10, shown is a block diagram of a SoC 1000 in accordance with an embodiment. Dashed lined boxes are optional features on more advanced SoCs. In FIG. 10, an interconnect unit(s) 1002 is coupled to: an application processor 1010 which includes a set of one or more cores 1002A-N (including constituent cache units 1004A-N); shared cache unit(s) 1006; a system agent unit 1012; a bus controller unit(s) 1016; an integrated memory controller unit(s) 1014; a set or one or more coprocessors 1020 which may include integrated graphics logic, an image processor, an audio processor, and a video processor; a static random access memory (SRAM) unit 1030; a direct memory access (DMA) unit 1032; and a display unit 1040 for coupling to one or more external displays. In one embodiment, the coprocessor(s) 1020 include a special-purpose processor, such as, for example, a network or communication processor, compression engine, GPGPU, a high-throughput MIC processor, embedded processor, or the like. In various embodiments, a cache line in a constituent cache unit 1004A-N or in a shared cache unit 1006 may be placed in a placeholder state in response to an ownership request for a cache line from an I/O agent in an I/O domain thereby reserving the cache line for the performance of a write operation by the I/O agent.

Embodiments of the mechanisms disclosed herein may be implemented in hardware, software, firmware, or a combination of such implementation approaches. Various embodiments may be implemented as computer programs or program code executing on programmable systems comprising at least one processor, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various embodiments also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

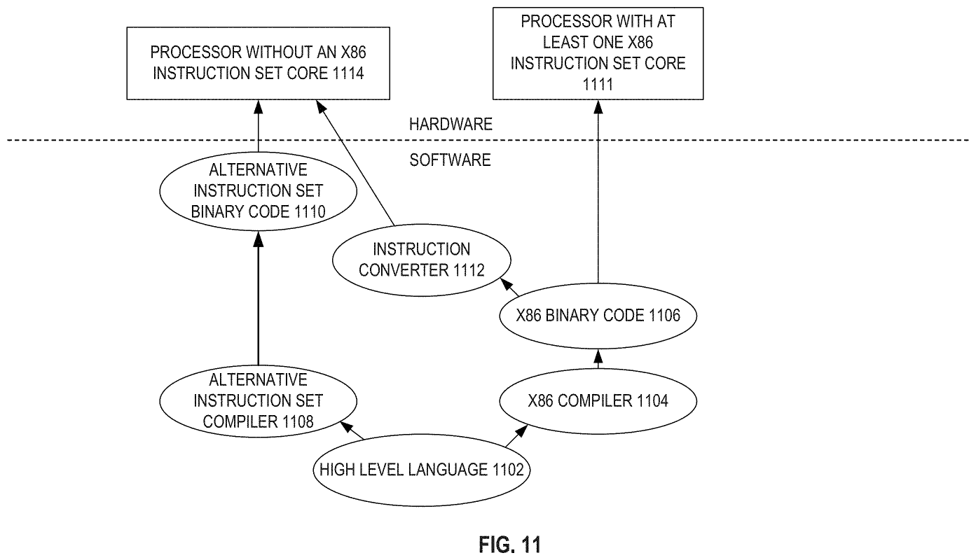

FIG. 11 is a block diagram contrasting the use of a software instruction converter to convert binary instructions in a source instruction set to binary instructions in a target instruction set according to various embodiments. In the illustrated embodiment, the instruction converter is a software instruction converter, although alternatively the instruction converter may be implemented in software, firmware, hardware, or various combinations thereof. FIG. 11 shows a program in a high level language 1102 may be compiled using an x86 compiler 1104 to generate x86 binary code 1106 that may be natively executed by a processor with at least one x86 instruction set core 1116. The processor with at least one x86 instruction set core 1116 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1104 represents a compiler that is operable to generate x86 binary code 1106 (e.g., object code) that can, with or without additional linkage processing, be executed on the processor with at least one x186 instruction set core 1116. Similarly, FIG. 11 shows the program in the high level language 1102 may be compiled using an alternative instruction set compiler 1108 to generate alternative instruction set binary code 1110 that may be natively executed by a processor without at least one x86 instruction set core 1114 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1112 is used to convert the x86 binary code 1106 into code that may be natively executed by the processor without an x86 instruction set core 1114. This converted code is not likely to be the same as the alternative instruction set binary code 1110 because an instruction converter capable of this is difficult to make; however, the converted code will accomplish the general operation and be made up of instructions from the alternative instruction set. Thus, the instruction converter 1112 represents software, firmware, hardware, or a combination thereof that, through emulation, simulation or any other process, allows a processor or other electronic device that does not have an x86 instruction set processor or core to execute the x86 binary code 1106.

The following examples pertain to further embodiments.

In an example, an apparatus includes an input/output (I/O) agent; and an I/O domain caching agent coupled to the I/O agent, the I/O domain caching agent to: receive an ownership request from the I/O agent to obtain ownership of a cache line in a compute domain cache hierarchy, transmit the ownership request to the compute domain to obtain ownership of the cache line in the compute domain cache hierarchy, receive an ownership confirmation from the compute domain to confirm that the I/O agent has been granted ownership of the cache line and that the cache line has been placed in a placeholder state, the placeholder state to indicate that the cache line has been reserved for performance of a write operation by the I/O agent, receive data to be written to the cache line from the I/O agent, and transmit the received data to the compute domain to cause the compute domain to write the data to the cache line and transition the cache line out of the placeholder state.

In an example, an I/O device is coupled to the I/O agent. The I/O agent is to receive the data to be written to the cache line from the I/O device.

In an example, the I/O domain caching agent is to receive a write operation completion from the compute domain to indicate that the data has been written to the cache line and that the cache line has been transitioned out of the placeholder state.

In an example, the I/O domain caching agent is to communicate with the compute domain via a home agent.

In an example, the placeholder state comprises temporary ownership of the cache line in the compute domain by the I/O agent.

In an example, the placeholder state is to further indicate that the cache line in the compute domain is dirty with respect to a memory.

In an example, the I/O agent is to obtain ownership of the cache line in the compute domain cache hierarchy without receipt of contents of the cache line.

In another example, a method includes: receiving at a compute domain caching agent, an ownership request for ownership of a cache line in a compute domain cache hierarchy from an input/output (I/O) agent; transitioning a state of the cache line to a placeholder state in response to the ownership request, the placeholder state to reserve the cache line for performance of a write operation by the I/O agent; transmitting an ownership confirmation, from the compute domain caching agent to the I/O agent, the ownership confirmation to confirm to that ownership of the cache line has been granted to the I/O agent; write data received from the I/O agent to the cache line in the compute domain cache hierarchy; and transitioning the state of the cache line from the placeholder state to another state.

In an example, the method further includes providing temporary ownership of the cache line in the compute domain cache hierarchy to the I/O agent by transitioning the state of the cache line to the placeholder state.

In an example, the method further includes indicating that the cache line in the compute domain cache hierarchy is dirty with respect to a memory by transitioning the state of the cache line to the placeholder state.

In an example, the method further includes enabling the I/O agent to obtain ownership of the cache line in the compute domain cache hierarchy without receipt of contents of the cache line.

In an example, the method further includes receiving communications from the I/O agent at the compute domain caching agent via a home agent.

In an example, the method further includes transitioning a state of the cache line to a placeholder state from one of an invalid state or a modified state.

In an example, the method further includes transitioning a state of the cache line from the placeholder state to one of an invalid state or a modified state.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system includes an input/output (I/O) domain and a compute domain coupled to the I/O domain. The I/O domain includes an I/O device; an I/O agent coupled to the I/O device; and an I/O domain caching agent coupled to the I/O agent. The compute domain is coupled to the I/O domain and includes at least one core; a compute domain cache hierarchy to store data accessible to the at least one core; and a compute domain caching agent to manage operation of the compute domain hierarchy, wherein the compute domain caching agent is to: in response to an ownership request to obtain ownership of a cache line in the compute domain cache hierarchy from the I/O agent, place a cache line in the compute domain cache hierarchy in a placeholder state, the placeholder state to reserve the cache line for performance of a write operation by the I/O agent, write data received from the I/O agent to the cache line in the compute domain cache hierarchy, and transition the state of the cache line out of the placeholder state.

In an example, the compute domain is disposed on a first die and the I/O domain is disposed on a second die.

In an example, a home agent is coupled to the compute domain and to the I/O domain, wherein communications between the I/O domain caching agent and the compute domain caching agent are routed via the home agent.

In an example, the placeholder state comprises temporary ownership of the cache line in the compute domain cache hierarchy by the I/O agent.

In an example, the I/O agent is to obtain ownership of the cache line in the compute domain cache hierarchy without receipt of contents of the cache line.

In an example, the cache line in the compute domain cache hierarchy is in one of the L1 cache, the L2 cache, or the L3 cache.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an input/output (I/O) agent; and
an I/O domain caching agent coupled to the I/O agent, the I/O domain caching agent to:
receive an ownership request from the I/O agent to obtain ownership of a cache line in a compute domain cache hierarchy,
transmit the ownership request to a compute domain to obtain ownership of the cache line in the compute domain cache hierarchy,
receive an ownership confirmation from the compute domain to confirm that the I/O agent has been granted ownership of the cache line and that the cache line has been placed in a placeholder state, the placeholder state to indicate that the cache line has been reserved for performance of a write operation by the I/O agent,
receive data to be written to the cache line from the I/O agent, and
transmit the received data to the compute domain to cause the compute domain to write the data to the cache line and transition the cache line out of the placeholder state.

2. The apparatus of claim 1, further comprising an I/O device coupled to the I/O agent, the I/O agent to receive the data to be written to the cache line from the I/O device.

3. The apparatus of claim 1, wherein the I/O domain caching agent is to receive a write operation completion from the compute domain to indicate that the data has been written to the cache line and that the cache line has been transitioned out of the placeholder state.

4. The apparatus of claim 1, wherein the I/O domain caching agent is to communicate with the compute domain via a home agent.

5. The apparatus of claim 1, wherein the placeholder state comprises temporary ownership of the cache line in the compute domain by the I/O agent.

6. The apparatus of claim 1, wherein the placeholder state is to further indicate that the cache line in the compute domain is dirty with respect to a memory.

7. The apparatus of claim 1, wherein the I/O agent is to obtain ownership of the cache line in the compute domain cache hierarchy without receipt of contents of the cache line.

8. A machine-readable medium comprising instructions stored thereon, which if performed by a machine, cause the machine to:
receive at a compute domain caching agent, an ownership request for ownership of a cache line in a compute domain cache hierarchy from an input/output (I/O) agent;
transition a state of the cache line to a placeholder state in response to the ownership request, the placeholder state to reserve the cache line for performance of a write operation by the I/O agent;
transmit an ownership confirmation, from the compute domain caching agent to the I/O agent, the ownership confirmation to confirm to that ownership of the cache line has been granted to the I/O agent;
write data received from the I/O agent to the cache line in the compute domain cache hierarchy; and
transition the state of the cache line from the placeholder state to another state.

9. The machine-readable medium of claim 8, further comprising instructions to cause the machine to provide temporary ownership of the cache line in the compute domain cache hierarchy to the I/O agent by transitioning the state of the cache line to the placeholder state.

10. The machine-readable medium of claim 8, further comprising instructions to cause the machine to indicate that the cache line in the compute domain cache hierarchy is dirty with respect to a memory by transitioning the state of the cache line to the placeholder state.

11. The machine-readable medium of claim 8, further comprising instructions to cause the machine to enable the I/O agent is to obtain ownership of the cache line in the compute domain cache hierarchy without receipt of contents of the cache line.

12. The machine-readable medium of claim 8, further comprising instructions to cause the machine to receive communications from the I/O agent at the compute domain caching agent via a home agent.

13. The machine-readable medium of claim 8, further comprising instructions to cause the machine to transition a state of the cache line to a placeholder state from one of an invalid state or a modified state.

14. The machine-readable medium of claim 8, further comprising instructions to cause the machine to transition a state of the cache line from the placeholder state to one of an invalid state or a modified state.

15. A system comprising:
an input/output (I/O) domain comprising:
an I/O device;
an I/O agent coupled to the I/O device; and
an I/O domain caching agent coupled to the I/O agent; and
a compute domain coupled to the I/O domain, the compute domain comprising:
at least one core;
a compute domain cache hierarchy to store data accessible to the at least one core; and
a compute domain caching agent to manage operation of the compute domain hierarchy, wherein the compute domain caching agent is to:
in response to an ownership request to obtain ownership of a cache line in the compute domain cache hierarchy from the I/O agent, place a cache line in the compute domain cache hierarchy in a placeholder state, the placeholder state to reserve the cache line for performance of a write operation by the I/O agent,
write data received from the I/O agent to the cache line in the compute domain cache hierarchy, and
transition the state of the cache line out of the placeholder state.

16. The system of claim 15, wherein the compute domain is disposed on a first die and the I/O domain is disposed on a second die.

17. The system of claim 15, further comprising a home agent coupled to the compute domain and to the I/O domain, wherein communications between the I/O domain caching agent and the compute domain caching agent are routed via the home agent.

18. The system of claim 15, wherein the placeholder state comprises temporary ownership of the cache line in the compute domain cache hierarchy by the I/O agent.

19. The system of claim 15, wherein the I/O agent is to obtain ownership of the cache line in the compute domain cache hierarchy without receipt of contents of the cache line.

20. The system of claim 15, wherein the cache line in the compute domain cache hierarchy is in one of a L1 cache, a L2 cache, or a L3 cache.
